(19) United States
(12) Patent Application Publication
(10) Pub. No.: US 2025/0117888 A1
(43) Pub. Date: Apr. 10, 2025

(54) IMAGE PROCESSING METHOD AND APPARATUS, ELECTRONIC DEVICE, AND STORAGE MEDIUM

(71) Applicants: Beijing Zitiao Network Technology Co., Ltd., Beijing (CN); Lemon Inc., Grand Cayman (KY)

(72) Inventors: Yanyan SUO, Beijing (CN); Shu SHI, Los Angeles, CA (US); Yongqiang GUI, Beijing (CN)

(21) Appl. No.: 18/820,102

(22) Filed: Aug. 29, 2024

(30) Foreign Application Priority Data
Oct. 7, 2023 (CN) 202311286886.6

(51) Int. Cl. G06T 5/50; G06T 3/60; G06V 10/74

(52) U.S. Cl. CPC G06T 5/50; G06T 3/60; G06V 10/761; G06T 2207/20132; G06T 2207/20221

(57) ABSTRACT

Embodiments of the present disclosure provide an image processing method and apparatus, an electronic device, and a storage medium. The method includes: receiving a first image sequence including a first image and transmitted based on a first transmission frame rate and a second image sequence including second images and transmitted based on a second transmission frame rate; generating a third image sequence based on the first image sequence and the second image sequence, where the third image sequence includes third images; the third images are in a one-to-one correspondence with the second images; image content of a first area in each of the third images comes from the second image; and image content of areas, other than the first area, in the third image comes from the first image; and generating a video stream based on the third image sequence and transmitting the video stream to a user.

### CROSS-REFERENCE TO RELATED APPLICATION(S)

This application claims priority to Chinese Application No. 202311286886.6 filed in Oct. 7, 2023, the disclosure of which is incorporated herein by reference in its entirety.

### FIELD

The present disclosure relates to the field of image processing, and in particular, to an image processing method and apparatus, an electronic device, and a storage medium.

### BACKGROUND

Currently, live video streaming services have been applied in various fields, such as in healthcare, concerts, and sports events. The basic process of live video streaming is as follows: A camera performs capturing on a live streaming site, and transmits a captured image sequence to a cloud server in real time, and the cloud server generates live video streams from a plurality of viewpoints based on the image sequence, and then sends a desired live video stream to a user based on the user's viewpoint information. In this process, the camera needs to upload the captured image sequence to the cloud server in real time, which results in the problem of occupying a high upstream bandwidth.

### SUMMARY

Embodiments of the present disclosure provide an image processing method and apparatus, an electronic device, and a storage medium, which can reduce the upstream bandwidth occupied for real-time transmission of an image sequence, thereby reducing computer resources used during live video streaming.

According to a first aspect, an embodiment of the present disclosure provides an image processing method. The method includes:
receiving a first image sequence transmitted based on a first transmission frame rate and a second image sequence transmitted based on a second transmission frame rate, where the first image sequence includes a first image; the second image sequence includes second images; image content of each of the second images is the same as image content of a first area in the first image; and the first transmission frame rate is less than the second transmission frame rate;
generating a third image sequence based on the first image sequence and the second image sequence, where the third image sequence includes third images; the third images are in a one-to-one correspondence with the second images; image content of the first area in each of the third images comes from the second image; and image content of areas, other than the first area, in the third image comes from the first image; and
generating a video stream based on the third image sequence and transmitting the video stream to a user.

According to a second aspect, an embodiment of the present disclosure provides an image processing method. The method includes:
transmitting a first image sequence based on a first transmission frame rate, and transmitting a second image sequence based on a second transmission frame rate, where the first image sequence includes a first image; the second image sequence includes second images; image content of each of the second images is the same as image content of a first area in the first image; and the first transmission frame rate is less than the second transmission frame rate.

According to a third aspect, an embodiment of the present disclosure provides an image processing apparatus, which is applied to a cloud server. The apparatus includes:
a data receiving unit configured to receive a first image sequence transmitted based on a first transmission frame rate and a second image sequence transmitted based on a second transmission frame rate, where the first image sequence includes a first image; the second image sequence includes second images; image content of each of the second images is the same as image content of a first area in the first image; and the first transmission frame rate is less than the second transmission frame rate;
an image generation unit configured to generate a third image sequence based on the first image sequence and the second image sequence, where the third image sequence includes third images; the third images are in a one-to-one correspondence with the second images; image content of the first area in each of the third images comes from the second image; and image content of areas, other than the first area, in the third image comes from the first image; and
a video transmission unit configured to generate a video stream based on the third image sequence, and transmit the video stream to a user.

According to a fourth aspect, an embodiment of the present disclosure provides an image processing apparatus, which is applied to an image capture system. The apparatus includes: a data transmission unit configured to transmit a first image sequence based on a first transmission frame rate, and transmit a second image sequence based on a second transmission frame rate, where the first image sequence includes a first image; the second image sequence includes second images; image content of each of the second images is the same as image content of a first area in the first image; and the first transmission frame rate is less than the second transmission frame rate.

According to a fifth aspect, an embodiment of the present disclosure provides an electronic device. The electronic device includes: a processor; and a memory configured to store computer-executable instructions that, when executed, cause the processor to implement the steps of the method according to the first or second aspect described above.

According to a sixth aspect, an embodiment of the present disclosure provides a computer-readable storage medium for storing computer-executable instructions that, when executed by a processor, cause the steps of the method according to the first or second aspect described above to be implemented.

In one or more embodiments of the present disclosure, the first image sequence transmitted based on the first transmission frame rate and the second image sequence transmitted based on the second transmission frame rate are received, where the first image sequence includes the first image, the second image sequence includes the second images, the image content of the second image is the same as the image content of the first area in the first image, and the first transmission frame rate is less than the second transmission frame rate; and the video stream is transmitted to the user based on the first image sequence and the second image sequence. It can be learned that with this embodiment, the first image can be transmitted at a low frame rate, i.e., the first transmission frame rate, the second images can be transmitted at a high frame rate, i.e., the second transmission frame rate, and the image content of the second image is the same as the image content of the first area in the first image, making it possible to implement high-frame-rate transmission of part of the content of the first image, e.g., live streaming content of interest to the user, and low-frame-rate transmission of the rest of the content in the first image, e.g., live streaming content of no interest to the user. Therefore, the upstream bandwidth occupied for real-time transmission of the image sequence is effectively reduced, thereby reducing computer resources used during live video streaming in a live video streaming scenario.

### BRIEF DESCRIPTION OF THE DRAWINGS

In order to more clearly describe the technical solutions in one or more embodiments of the present disclosure or in the prior art, the accompanying drawings for describing the embodiments or the prior art will be briefly described below. Apparently, the accompanying drawings in the description below show only some of the embodiments recorded in the present disclosure, and persons of ordinary skill in the art may still derive other accompanying drawings from these accompanying drawings without creative efforts.

FIG. 1 is a schematic diagram of an application scenario of an image processing method according to an embodiment of the present disclosure;

FIG. 2 is a schematic flowchart of an image processing method according to an embodiment of the present disclosure;

FIG. 3 is a schematic diagram of a first area according to an embodiment of the present disclosure;

FIG. 4 is a schematic flowchart of an image processing method according to another embodiment of the present disclosure;

FIG. 5 is a schematic diagram of a structure of an image processing apparatus according to an embodiment of the present disclosure;

FIG. 6 is a schematic diagram of a structure of an image processing apparatus according to another embodiment of the present disclosure; and

FIG. 7 is a schematic diagram of a structure of an electronic device according to an embodiment of the present disclosure.

### DETAILED DESCRIPTION OF EMBODIMENTS

In order to make those skilled in the art better understand the technical solutions in one or more embodiments of the present disclosure, the technical solutions in one or more embodiments of the present disclosure will be clearly and completely described below with reference to the accompanying drawings in one or more embodiments of the present disclosure. Apparently, the described embodiments are merely some rather than all of the embodiments of the present disclosure. All other embodiments obtained by persons of ordinary skill in the art based on one or more embodiments of the present disclosure without creative efforts shall fall within the scope of protection of the present disclosure.

Embodiments of the present disclosure provide an image processing method, which can reduce the upstream bandwidth occupied for real-time transmission of an image sequence, thereby reducing computer resources used during live video streaming. First, it should be noted that in various embodiments of the present disclosure, the frame rate refers to frames per second (FPS).

FIG. 1 is a schematic diagram of an application scenario of an image processing method according to an embodiment of the present disclosure. As shown in FIG. 1, the scenario includes a camera, a camera-side server, a cloud server, and a terminal device of a user. The camera and the camera-side server are both located on a live streaming site, and together form an image capture system. Therefore, the camera-side server may also be referred to as a live streaming local server. In an embodiment, the camera-side server may be a mobile phone or another handheld terminal device, or the camera-side server may be integrated into the camera in the form of a service module. The cloud server is a remote server. The terminal device of the user may be a virtual reality (VR) device. In FIG. 1, the camera may capture an image of the live streaming site, the camera-side server communicates with both the camera and the cloud server, and the camera-side server cooperates with the cloud server to execute the image processing method in this embodiment. With the image processing method in this embodiment, the cloud server also sends a video stream to the terminal device of the user, where the video stream may be a live video stream.

In an embodiment, in FIG. 1, the camera captures a first image at a preset frame rate and sends the first image to the camera-side server, and the camera-side server generates a second image based on the first image, where image content of the second image is the same as image content of a first area in the first image. The camera-side server generates a first image sequence based on the first image, where the first image sequence includes the first image, and the number of first images contained per second in the first image sequence is equal to a first transmission frame rate. The camera-side server generates a second image sequence based on the second images, where the second image sequence includes the second images, and the number of second images contained per second in the second image sequence is equal to a second transmission frame rate. The camera-side server further transmits the first image sequence to the cloud server based on the first transmission frame rate, and transmits the second image sequence to the cloud server based on the second transmission frame rate, where the first transmission frame rate is less than the second transmission frame rate, and the second transmission frame rate is less than or equal to the preset frame rate at which the camera captures the first image.

The cloud server generates a third image sequence based on the first image sequence and the second image sequence, where the third image sequence includes third images, the third images are in a one-to-one correspondence with the second images, image content of a first area in each of the third images comes from the second image, and image content of areas, other than the first area, in the third image comes from the first image. The cloud server further generates a video stream based on the third image sequence, and transmits the video stream to the user.

It can be learned that through the cooperation of the camera-side server and the cloud server, the first image can be transmitted to the cloud server at a low frame rate, i.e., the first transmission frame rate, the second images can be transmitted to the cloud server at a high frame rate, i.e., the second transmission frame rate, and the image content of the second image is the same as the image content of the first area in the first image, making it possible to implement high-frame-rate transmission of part of the content of the first image, e.g., live streaming content of interest to the user, and low-frame-rate transmission of the rest of the content in the first image, e.g., live streaming content of no interest to the user. Therefore, the upstream bandwidth occupied for real-time upload of the captured image sequence to the cloud server is effectively reduced, thereby reducing computer resources used during live video streaming in a live video streaming scenario.

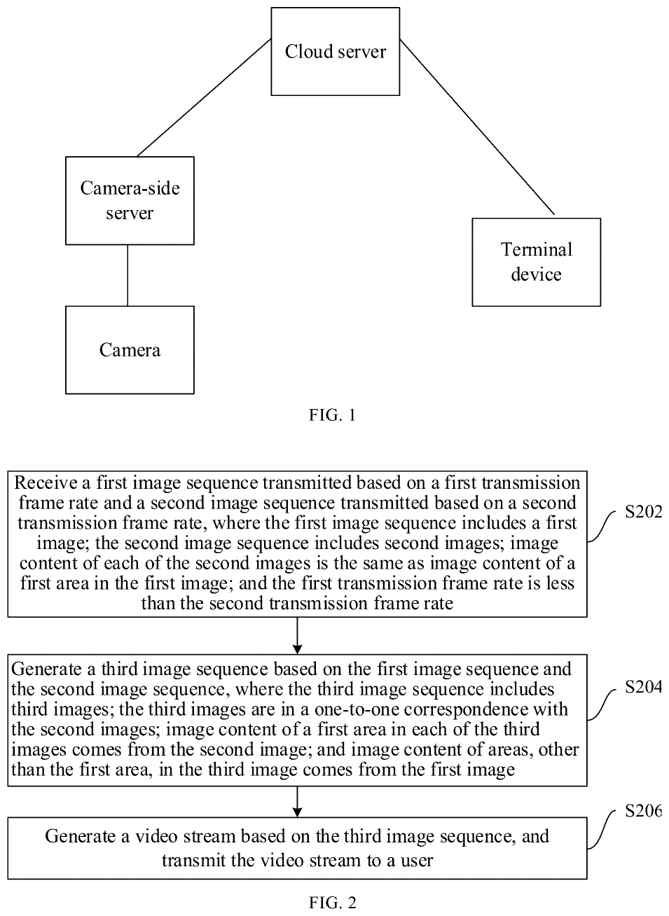

FIG. 2 is a schematic flowchart of an image processing method according to an embodiment of the present disclosure. As shown in FIG. 2, the flow includes:

step S202: receiving a first image sequence transmitted based on a first transmission frame rate and a second image sequence transmitted based on a second transmission frame rate, where the first image sequence includes a first image; the second image sequence includes second images; image content of each of the second images is the same as image content of a first area in the first image; and the first transmission frame rate is less than the second transmission frame rate;

step S204: generating a third image sequence based on the first image sequence and the second image sequence, where the third image sequence includes third images; the third images are in a one-to-one correspondence with the second images; image content of a first area in each of the third images comes from the second image; and image content of areas, other than the first area, in the third image comes from the first image; and step S206: generating a video stream based on the third image sequence and transmitting the video stream to a user.

In this embodiment, the first image sequence transmitted based on the first transmission frame rate and the second image sequence transmitted based on the second transmission frame rate are received, where the first image sequence includes the first image, the second image sequence includes the second images, the image content of the second image is the same as the image content of the first area in the first image, and the first transmission frame rate is less than the second transmission frame rate; and the video stream is transmitted to the user based on the first image sequence and the second image sequence. It can be learned that with this embodiment, the first image can be transmitted at a low frame rate, i.e., the first transmission frame rate, the second images can be transmitted at a high frame rate, i.e., the second transmission frame rate, and the image content of the second image is the same as the image content of the first area in the first image, making it possible to implement high-frame-rate transmission of part of the content of the first image, e.g., live streaming content of interest to the user, and low-frame-rate transmission of the rest of the content in the first image, e.g., live streaming content of no interest to the user. Therefore, the upstream bandwidth occupied for real-time transmission of the image sequence is effectively reduced, thereby reducing computer resources used during live video streaming in a live video streaming scenario.

Of course, the method in this embodiment can also be applied in a video-on-demand scenario, and can also achieve the effect of reducing the upstream bandwidth occupied for real-time transmission of an image sequence, thereby saving computer resources. In the video-on-demand scenario, the video stream generated based on the third image sequence may be an on-demand video stream.

The specific process in FIG. 2 will be described in detail by taking the application of the method flow in FIG. 2 to the cloud server as an example. Of course, the method flow in FIG. 2 is not limited to being executed by the cloud server, but can also be executed by other devices, such as a local server or a local terminal device, which is not limited in this embodiment.

In step S202 above, the cloud server receives the first image sequence transmitted by the image capture system based on the first transmission frame rate and the second image sequence transmitted based on the second transmission frame rate. For example, the cloud server receives the first image sequence transmitted by the camera-side server in the image capture system based on the first transmission frame rate and the second image sequence transmitted thereby based on the second transmission frame rate. The first image sequence includes a first image captured by the image capture system, e.g., including the first image captured by the camera, and the number of first images contained per second in the first image sequence is equal to the first transmission frame rate. The second image sequence includes the second images, and the number of second images contained per second in the second image sequence is equal to the second transmission frame rate. The image content of the second image is the same as the image content of the first area in the first image. The first transmission frame rate is less than the second transmission frame rate.

In an embodiment, during live streaming, the camera captures a first image of the live streaming site at a preset frame rate and sends the first image to the camera-side server, and the camera-side server crops a first area in the first image, to obtain a second image, where the second image is used to represent the image content of the first area in the first image.

The camera-side server generates a first image sequence based on the first image, and the number of first images contained per second in the first image sequence is equal to the first transmission frame rate. For example, with a preset frame rate of 60 fps and a first transmission frame rate of 1 fps, the camera-side server selects, from 60 first images captured per second, one first image that is captured first, and combine one first image selected per second into a first image sequence.

The camera-side server generates a second image sequence based on the second images, and the number of second images contained per second in the second image sequence is equal to the second transmission frame rate. For example, with a preset frame rate of 60 fps and a second transmission frame rate of 30 fps, the camera-side server generates 60 corresponding second images based on the 60 first images captured per second, selects, at intervals of one second image, 30 second images from the 60 second images captured per second, and combines the 30 second images selected per second into a second image sequence.

Finally, the camera-side server transmits the first image sequence to the cloud server based on the first transmission frame rate, and transmits the second image sequence to the cloud server based on the second transmission frame rate, so that the cloud server pushes a live video stream to the user.

In an embodiment, the first area is a predetermined area of most interest to the user when watching a live stream. Therefore, transmitting the second image at a high frame rate and transmitting the first image at a low frame rate can ensure that the user can see the picture of most interest to them and thus ensure the watching experience of the user during live streaming while reducing the upstream bandwidth occupied for real-time upload of the captured image sequence to the cloud server.

FIG. 3 is a schematic diagram of a first area according to an embodiment of the present disclosure. As shown in FIG. 3, the live streaming site includes a sunflower and surrounding background images, such as grass and white clouds. When watching the live stream, the user usually focuses on an area where the sunflower is located. Therefore, in a first image captured by the camera, the area including the sunflower may be determined as the first area. By transmitting the picture of the area including the sunflower at a high frame rate and transmitting the whole image captured by the camera at a low frame rate, the upstream bandwidth occupied for real-time upload of the captured image sequence to the cloud server can be effectively reduced without affecting the watching experience of the user during live streaming.

In step S204 above, the cloud generates the third image sequence based on the first image sequence and the second image sequence. The third image sequence includes the third images, and the third images are in a one-to-one correspondence with the second images. Therefore, the number of third images contained per second in the third image sequence is equal to a second preset frame rate. The image content of the first area in the third image comes from the second image, and the image content of the areas, other than the first area, in the third image comes from the first image.

In an embodiment, the cloud server generating the third image sequence based on the first image sequence and the second image sequence includes:
augmenting the first image sequence based on the second transmission frame rate, where first images in the augmented first image sequence are in a one-to-one correspondence with the second images;
replacing the image content of the first area in the first image with the corresponding second image, where the first images are the third images; and
generating the third image sequence based on the third images.

In this embodiment, after the cloud server receives the first image sequence and the second image sequence, since the number of first images contained per second in the first image sequence is equal to the first transmission frame rate, the number of second images contained per second in the second image sequence is equal to the second transmission frame rate, and the second transmission frame rate is greater than the first transmission frame rate, the cloud server first augments the first image sequence based on the second transmission frame rate, where first images in the augmented first image sequence are in a one-to-one correspondence with the second images, and the number of first images contained per second in the augmented first image sequence is equal to the second transmission frame rate.

In an embodiment, the first image sequence is augmented by duplicating the first image in the first image sequence. For example, with a first transmission frame rate of 1 fps, one first image contained per second in the first image sequence, a second transmission frame rate of 30 fps, and 30 second images contained per second in the second image sequence, upon which it can be determined that every one first image corresponds to 30 second images, each first image is duplicated until 30 first images are obtained, such that an augmented first image sequence is obtained. The augmented first image sequence contains 30 first images per second, which allows the first images in the augmented first image sequence to be in a one-to-one correspondence with the second images.

Then, on the basis that the first images are in a one-to-one correspondence with the second images, the cloud server replaces the image content of the first area in the first image with the corresponding second image, where the first images are the third images. Finally, the cloud server combines the third images into the third image sequence. It can be learned that in the third image sequence, the third images are in a one-to-one correspondence with the second images, and the number of third images contained per second in the third image sequence is equal to the second preset frame rate.

It can be learned that with this embodiment, the third image sequence can be generated, based on the first image sequence transmitted at a low frame rate and the second image sequence transmitted at a high frame rate, by replacing the image content of the first area. In a live streaming scenario, a lower first transmission frame rate results in a lower real-time performance of the first image received by the cloud server, while a higher second transmission frame rate results in a higher real-time performance of the second image received by the cloud server. Since the image content of the first area in the third image comes from the second image, and the image content of the areas, other than the first area, in the third image comes from the first image, the image content of the first area in the third image has a higher real-time performance, and the image content of the areas, other than the first area, in the third image has a lower real-time performance. Therefore, the third image may be referred to as a weak real-time image in the live streaming scenario.

In an embodiment, replacing the image content of the first area in the first image with the corresponding second image includes:
determining a coordinate correspondence between pixel points in the second image and pixel points in the first area in the first image based on a width and height of the first image, a width and height of the first area, a spherical angle range covered by the first area, and coordinates of a center point of a video picture of the user; and
replacing the pixel points in the first area in the first image with the pixel points in the corresponding second image based on the coordinate correspondence.

In this embodiment, the coordinate correspondence between the pixel points in the second image and the pixel points in the first area in the first image may be determined, based on the width and height of the first image, the width and height of the first area, the spherical angle range covered by the first area, and the coordinates of the center point of the video picture of the user, through the following formulas (1) to (4).

$${u}_{1} = \frac{( {m}_{1} + 0.5 )}{W} * 2 * π ( 0 \leq {m}_{1} < W ) ) \qquad ( 1 )$$

$${v}_{1} = \frac{( {n}_{1} + 0.5 )}{H} * π ( 0 \leq {n}_{1} < H ) ) \qquad ( 2 )$$

$${m}_{2} = {u}_{2} / {F}_{w} * {C}_{w} - 0.5 ( 0 \leq {m}_{2} < {C}_{w} ) \qquad ( 3 )$$

$${n}_{2} = {v}_{2} / {F}_{h} * {C}_{h} - 0.5 ( 0 \leq {n}_{2} < {C}_{h} ) \qquad ( 4 )$$

In formulas (1) to (4), W and H are respectively the width and height of the first image, C_{w} and Cₕ are respectively the width and height of the first area, F_{w} and Fₙ are respectively spherical angle ranges covered by the first area, i.e., F_{w}*Fₙ, m₁ and n₁ are coordinates of the pixel points in the first area of the first image, m₂ and n₂ are coordinates of the pixel points in the second image, u₁ and v₁ are longitude and latitude coordinates of the pixel points in the first area of the first image on a unit sphere, and u₁ and v₁ can be respectively multiplied by an inverse of a rotation matrix R, to obtain u₂ and v₂. Formulas (3) and (4) are established provided that: (0≤u₂<F_{w}) and (0≤v₂<Fₕ).

The rotation matrix R can be calculated based on the coordinates (yaw, pitch, roll) of the center point of the video picture of the user when watching the live stream. The specific calculation formula is as follows:

$$R = [ \begin{matrix}cos ( α ) cos ( β ) & \begin{matrix}cos ( α ) sin ( β ) sin ( γ ) - \\ sin ( α ) cos ( γ )\end{matrix} & \begin{matrix}cos ( α ) sin ( β ) cos ( γ ) + \\ sin ( α ) sin ( γ )\end{matrix} \\ sin ( α ) cos ( β ) & \begin{matrix}sin ( α ) sin ( β ) sin ( γ ) + \\ cos ( α ) cos ( γ )\end{matrix} & \begin{matrix}sin ( α ) sin ( β ) cos ( γ ) - \\ cos ( α ) sin ( γ )\end{matrix} \\ - sin ( β ) & cos ( β ) sin ( γ ) & cos ( β ) cos ( γ )\end{matrix} ] \qquad ( 5 )$$

In formula (5), α, β, and γ represent yaw, pitch, and roll, respectively. The coordinates of the center point of the video picture of the user are coordinates of a center point of a picture of a VR device of the user, where yaw represents a yaw angle, pitch represents a pitch angle, and roll represents a roll angle. The coordinates of the center point of the video picture of the user may be used to represent viewpoint information of the user.

In this embodiment, when live video streams are distributed to each user, it is necessary to generate a corresponding third image sequence, i.e., a corresponding third image for each user. During the process of generating the third image using the formulas described above, respective coordinates (yaw, pitch, roll) of each user are used as the coordinates (yaw, pitch, roll) of the center point of the video picture. By calculating the respective rotation matrix R for each user based on the respective coordinates (yaw, pitch, roll) of each user, and multiplying the inverse of the rotation matrix R by u₁ and v₁, an image portion to be viewed by the user can be rotated to the center of a field of view of the user in the respective third image for each user, so that when the user is watching their respective live video stream, the viewpoint of the live video stream matches the viewpoint of the user, thereby enhancing the watching experience during live streaming.

After the above coordinate correspondence is calculated, the pixel points in the first area in the first image can be replaced with the pixel points in the corresponding second image.

It can be learned that with this embodiment, the coordinate correspondence between the pixel points in the second image and the pixel points in the first area in the first image can be determined based on the width and height of the first image, the width and height of the first area, the spherical angle range covered by the first area, and the coordinates of the center point of the video picture of the user, and the pixel points in the first area in the first image can be efficiently and quickly replaced with the pixel points in the corresponding second image based on the coordinate correspondence, so that the efficiency of generating the third images is improved.

In step S206 above, the cloud server generates the video stream based on the third image sequence, and transmits the video stream to the user. The video stream may be a live video stream or an on-demand video stream. In an example, the cloud server crops the third images in the third image sequence based on the viewpoint information of the user, generates a VAM video stream consistent with the viewpoint of the user, and sends, to the VR device of the user, the VAM video stream as a live video stream or an on-demand video stream. The transmission frame rate at which the live video stream or the on-demand video stream is transmitted to the user is less than or equal to the second transmission frame rate.

VAM (Visible Area+Margin) relates to a video picture transmitted to the user. When a video playback device of the user is a VR device, the field of view (FOV) of the video playback device can be represented by the FOV of the VR device. The FOV corresponding to the VAM is greater than the FOV of the video playback device. In the VAM picture, the FOV of a visible area is equal to the FOV of the video playback device, and the margin represents the extra FOV of the VAM frame relative to the video playback device.

The VAM video stream is sent to the VR device of the user as the live or on-demand video stream. When the user wears the VR device to watch the video by making small head movements, the VR device can directly use the Margin area in the video picture for local rendering, so as to accommodate the small head movements of the user, without a need to obtain a new video stream from the cloud server, making it possible to control the delay of the picture update within a preset duration, such as 25 ms, thereby preventing the user from experiencing picture lagging or even dizziness.

In an embodiment, both the first transmission frame rate and the second transmission frame rate may be the frame rate set by the user, or the frame rate adaptively adjusted according to network conditions.

In an embodiment, after the image content of the areas, other than the first area, in the first image has changed, the user can see the changed image content only after a long time or may miss out the changed image content due to the use of a lower first transmission frame rate for transmission of the first image, as a complete image captured by the camera, from the camera-side server to the cloud server, which degrades the experience of the user for viewing a video. On this basis, in an embodiment, the second image sequence further includes a fourth image, where the fourth image is used to represent image content of a second area in the first image, image content of the fourth image is the same as the image content of the second area in the first image, and the second area is located in areas other than the first area. The above method flow further includes:
determining whether to update the first image, based on a similarity between the image content of the fourth image and the image content in the second area in the first image; and
if so, updating the first image.

In this embodiment, the second image sequence further includes the fourth image. The fourth image is used to represent the image content of the second area in the first image, the image content of the fourth image is the same as the image content of the second area in the first image, the second area is located in areas other than the first area, e.g., the second area may be a small image area close to the first area, and the fourth image is also transmitted at the second transmission frame rate. The similarity between the image content of the fourth image and the image content of the second area in the first image is determined. If the similarity is less than a similarity threshold, it is determined that the image content of the areas other than the first area has changed greatly, and the cloud server then determines that the first image needs to be updated. Otherwise, it is determined that the image content of the areas other than the first area has not changed greatly, and the cloud server then determines that the first image does not need to be updated.

After determining that the first image needs to be updated, the cloud server notifies the camera-side server in the image capture system to send a first image at a current moment, and after sending the first image, the camera-side server continues to transmit the first image sequence to the cloud server at the first transmission frame rate. For example, the camera-side server sends a first image to the cloud server at 02 second, and according to the first transmission frame rate, the camera-side server should continue to send a first image to the cloud server at 04 second. However, the cloud server determines at 03 second that there is a low similarity between image content of the latest received fourth image and image content of a second area in the first image that is received at 02 second, and therefore, the cloud server notifies, at 03 second, the camera-side server to transmit a first image. In response to the notification, the camera-side server sends a first image to the cloud server at 03 second, and continues to transmit the first image sequence at the first transmission frame rate.

It can be learned that with this embodiment, by sending a fourth image sequence, which is equivalent to increasing some pixels around the first area to represent the image content of other areas, it can be determined whether to update the first image based on the similarity between the image content of the fourth image and the image content of the second area in the first image, thus avoiding the situation that after the image content of the areas, other than the first area, in the first image has changed, the user can see the changed image content only after a long time or may miss out the changed image content due to the use of a lower first transmission frame rate for transmission from the camera-side server to the cloud server, and enhancing the experience of the user for viewing a video.

In an embodiment, the first area, as an area of interest to the user, may be an area preset by the user, or may be determined according to the point of interest to a large number of users when watching a video. On this basis, in an embodiment, after transmitting the video stream to the user, the above method flow further includes:
updating coordinates of a center point of the first area in the first image based on the coordinates of the center point of the video picture of the user when watching the video stream; and
updating the first area in the first image based on the updated coordinates of the center point of the first area.

In this embodiment, the coordinates of the center point of the video pictures of a plurality of users when watching the video stream are obtained. When the user is watching the video stream through the VR device, the coordinates of a center point of a video picture of the VR device are the coordinates of the center point of the video picture of the user when watching the video stream, and the VR device can transmit the coordinates of the center point of the video picture of the VR device to the cloud server in real time. The coordinates of the center point of the video picture of the user when watching the video stream changes as the viewpoint of the user changes, and thus can represent the viewpoint information of the user.

The coordinates of the center point of the first area in the first image are updated based on the same or similar coordinates of the center point of video pictures of a plurality of users. For example, when the coordinates of the center point of the video pictures of a large number of users all fall on and around coordinates (10, 10, 10), the coordinates of the center point of the first area in the first image are updated based on the coordinates (10, 10, 10), e.g., the coordinates (10, 10, 10) are taken as the updated coordinates of the center point of the first area in the first image.

Then, the first area is updated in the first image based on the updated coordinates of the center point of the first area. For example, the updated coordinates of the center point of the first area, which are used to update the first area in the first image, are sent to the image capture system, and the image capture system can update the first area in the first image based on the updated coordinates of the center point of the first area and a preset size of the first area.

It can be learned that with this embodiment, during the process of the user watching the video stream, the coordinates of the center point of the first area in the first image can be updated based on the coordinates of the center point of the video picture of the user when watching the video stream, and the updated coordinates of the center point of the first area can be sent to the image capture system to update the first area, so that the updated first area is the image area of interest to most of the users.

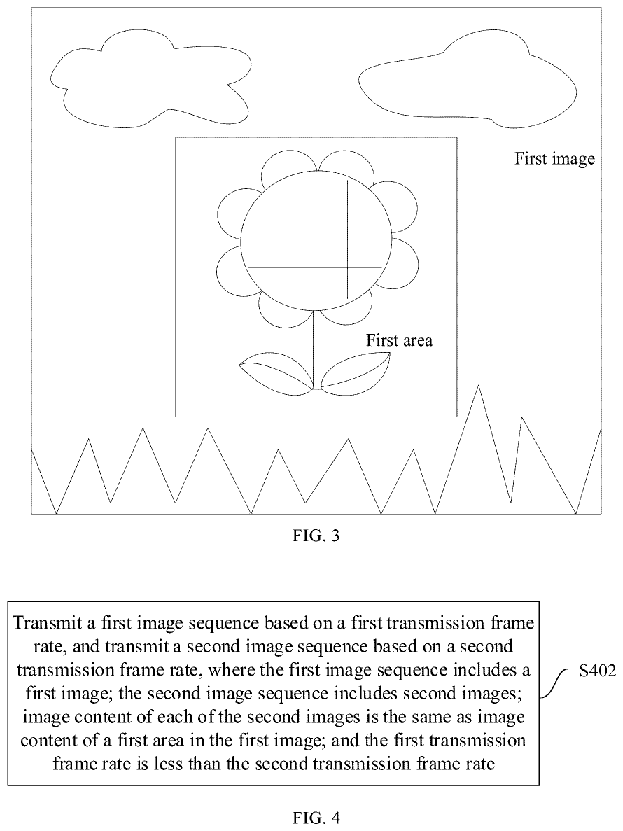

FIG. 4 is a schematic flowchart of an image processing method according to another embodiment of the present disclosure. As shown in FIG. 4, the method includes the following step: step S402: transmitting a first image sequence based on a first transmission frame rate, and transmitting a second image sequence based on a second transmission frame rate, where the first image sequence includes a first image; the second image sequence includes second images; image content of each of the second images is the same as image content of a first area in the first image; and the first transmission frame rate is less than the second transmission frame rate.

It can be learned that with this embodiment, the first image can be transmitted at a low frame rate, i.e., the first transmission frame rate, the second images can be transmitted at a high frame rate, i.e., the second transmission frame rate, and the second image is used to represent the image content of the first area in the first image, making it possible to implement high-frame-rate transmission of part of the content of the first image, e.g., live streaming content of interest to the user, and low-frame-rate transmission of the rest of the content in the first image, e.g., live streaming content of no interest to the user. Therefore, the upstream bandwidth occupied for real-time transmission of the image sequence is effectively reduced, thereby reducing computer resources used during live video streaming in a live video streaming scenario.

The method flow in FIG. 4 can be applied to and executed by the image capture system. Of course, it can also be applied to and executed by other devices such as a local server or a remote server, which is not limited herein. The specific process in FIG. 4 will be described in detail by taking the application of the method flow in FIG. 4 to the image capture system as an example.

In an embodiment, before transmitting the first image sequence based on the first transmission frame rate, and transmitting the second image sequence based on the second transmission frame rate, the above method flow further includes:
capturing the first image according to a preset capture frame rate;
determining the first area in the first image; and
cropping the first area in the first image, to obtain the second image.

In this embodiment, during live streaming, the camera captures a first image of the live streaming site at a preset frame rate and sends the first image to the camera-side server, and the camera-side server determines a first area in the first image, and crops the first area in the first image, to obtain a second image, where the second image is used to represent the image content of the first area in the first image.

It can be learned that with this embodiment, the first image can be captured at the preset capture frame rate, the first area can be determined in the first image, and the first area can be cropped in the first image to obtain the second image. Therefore, the first image and the second image can be generated efficiently and quickly.

In an embodiment, the first area, as an area of interest to the user, may be an area preset by the user, or may be determined according to the point of interest to a large number of users when watching a video, or determined according to changes in image content of adjacent first images. On this basis, in an embodiment, determining the first area in the first image includes:
determining the first area in the first image based on a difference in image content of a plurality of first images with adjacent timestamps.

In an embodiment, during live streaming, the camera captures first images of the live streaming site at a preset frame rate and sends the first images to the camera-side server, and the camera-side server marks each first image with a timestamp, where a temporal order of the timestamps is consistent with an order of receiving the first images. The camera-side server determines, as the coordinates of the center point of the first area, coordinates of a center point of an area with a large change in image content based on the difference in image content of a plurality of first images with adjacent timestamps, and determines the first area in the first image based on the coordinates of the center point of the first area and a preset size of the first area.

In an embodiment, the difference in the image content of the plurality of first images with adjacent timestamps can be calculated by calculating a difference between pixel values of corresponding pixel points, so as to determine the area with a large change in image content and the coordinates of the center point of the area. Alternatively, the difference in the image content of the plurality of first images with adjacent timestamps is determined by using a pre-trained deep learning model, and the area with a large change in image content and the coordinates of the center point of the area are determined by using the pre-trained deep learning model.

Of course, in an embodiment, the camera-side server may also determine the area with a large change in image content as the first area based on the difference in image content of the plurality of first images with adjacent timestamps, and in this case, the size of the first area is not the preset size, but a size adaptively determined according to the changes in image content of the first image.

It can be learned that with this embodiment, the first area can be determined in the first image according to the difference in image content of the plurality of first images with adjacent timestamps, so that the first area is the area with a large change in image content, and the first area is an area of interest to the user when watching the video.

In an embodiment, cropping the first area in the first image, to obtain the second image includes:
rotating the first image based on the coordinates of the center point of the first area, where the coordinates of the center point of the first area in the rotated first image are located at a center of the rotated first image; and
cropping the first area in the rotated first image, to obtain the second image.

In this embodiment, first, the rotation matrix is calculated based on the coordinates of the center point of the first area, and the first image is rotated according to the rotation matrix, where the coordinates of the center point of the first area in the rotated first image are located at the center of the rotated first image, and the first area is thus rotated to the exact center of the first image, so that the pixel density in the first area is improved.

The coordinates of the center point of the first area may be represented as (α, β, γ), where α, β, and γ represent yaw, pitch, and roll, respectively, and the rotation matrix R can be calculated based on the coordinates of the center point of the first area with reference to formula (5) described above.

Then, the first area is cropped, based on the size of the first area, in the rotated first image, to obtain the second image.

It can be learned that with this embodiment, by rotating the first image and cropping the first area in the rotated first image, the first area can be rotated to the exact center of the first image, so that the pixel density in the first area is improved.

In an embodiment, after transmitting the first image sequence based on the first transmission frame rate, and transmitting the second image sequence based on the second transmission frame rate, the above method flow further includes:
obtaining the updated coordinates of the center point of the first area; and
updating the first area in the first image based on the updated coordinates of the center point of the first area.

In this embodiment, the cloud server can obtain the coordinates of the center point of the video pictures of a plurality of users when watching the video stream in the above manner. When the user is watching the video stream through the VR device, the coordinates of a center point of a video picture of the VR device are the coordinates of the center point of the video picture of the user when watching the video stream, and the VR device can transmit the coordinates of the center point of the video picture of the VR device to the cloud server in real time. The coordinates of the center point of the video picture of the user when watching the video stream changes as the viewpoint of the user changes, and thus can represent the viewpoint information of the user.

The cloud server updates the coordinates of the center point of the first area in the first image based on the same or similar coordinates of the center point of the video pictures of a plurality of users. For example, when the coordinates of the center point of the video pictures of a large number of users all fall on and around coordinates (10, 10, 10), the coordinates of the center point of the first area in the first image are updated based on the coordinates (10, 10, 10), e.g., the coordinates (10, 10, 10) are taken as the updated coordinates of the center point of the first area in the first image.

Then, the cloud server sends the updated coordinates of the center point of the first area to the image capture system, and the image capture system can update the first area in the first image based on the updated coordinates of the center point of the first area and a preset size of the first area.

It can be learned that with this embodiment, the first area can be updated in real time during the process of the user watching the video stream, so that the updated first area is the image area of interest to most of the users.

The specific process of the image processing method applied to an image sending end, such as the image capture system, has been described above. For the working process of an image receiving end, such as the cloud server, or any aspects that have not been described, reference may be made to the description of FIG. 1, which will not be repeated herein.

In conclusion, there is provided an image processing method, which can ensure that when the user is watching a live or on-demand video from any viewpoint, the first image is transmitted at a low frame rate, i.e., the first transmission frame rate, and the second images are transmitted at a high frame rate, i.e., the second transmission frame rate, making it possible to implement high-frame-rate transmission of part of the content of the first image, e.g., live streaming content of interest to the user, and low-frame-rate transmission of the rest of the content in the first image, e.g., live streaming content of no interest to the user. Therefore, the upstream bandwidth occupied for real-time transmission of the image sequence is effectively reduced, thereby reducing computer resources used during live video streaming in a live video streaming scenario. Moreover, experiments show that the above image processing method, when applied in a live streaming scenario, can greatly reduce the upstream bandwidth occupied for real-time upload of the image sequence to the cloud server without reducing the quality of the live streaming picture.

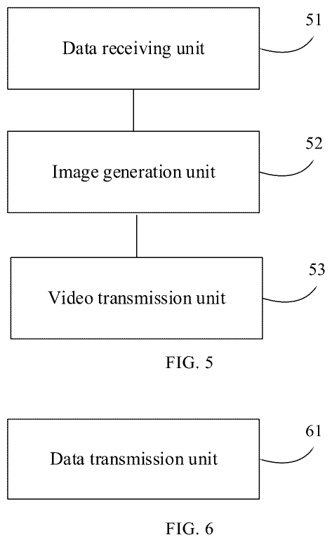

FIG. 5 is a schematic diagram of a structure of an image processing apparatus according to an embodiment of the present disclosure. As shown in FIG. 5, the apparatus includes:
a data receiving unit 51 configured to receive a first image sequence transmitted based on a first transmission frame rate and a second image sequence transmitted based on a second transmission frame rate, where the first image sequence includes a first image; the second image sequence includes second images; image content of each of the second images is the same as image content of a first area in the first image; and the first transmission frame rate is less than the second transmission frame rate;
an image generation unit 52 configured to generate a third image sequence based on the first image sequence and the second image sequence, where the third image sequence includes third images; the third images are in a one-to-one correspondence with the second images; image content of the first area in each of the third images comes from the second image; and image content of areas, other than the first area, in the third image comes from the first image; and
a video transmission unit 53 configured to generate a video stream based on the third image sequence, and transmit the video stream to a user.

Optionally, the image generation unit 52 is specifically configured to:
augment the first image sequence based on the second transmission frame rate, where the first images in the augmented first image sequence are in a one-to-one correspondence with the second images;
replace image content of the first area in the first image with the corresponding second image, where the first images are the third images; and
generate the third image sequence based on the third images.

Optionally, the image generation unit 52 is further specifically configured to:
determine a coordinate correspondence between pixel points in the second image and pixel points in the first area in the first image based on a width and height of the first image, a width and height of the first area, a spherical angle range covered by the first area, and coordinates of a center point of a video picture of the user; and
replace the pixel points in the first area in the first image with the pixel points in the corresponding second image based on the coordinate correspondence.

Optionally, the second image sequence further includes a fourth image; where image content of the fourth image is the same as image content of a second area in the first image; and the second area is located in areas other than the first area. The apparatus further includes a first update unit configured to:
determine whether to update the first image, based on a similarity between the image content of the fourth image and the image content in the second area in the first image; and
if so, update the first image.

Optionally, the apparatus further includes a second update unit configured to:
after the video stream is transmitted to the user, update coordinates of a center point of the first area in the first image based on the coordinates of the center point of the video picture of the user when watching the video stream; and
update the first area in the first image based on the updated coordinates of the center point of the first area.

The image processing apparatus in this embodiment of the present disclosure can implement various processes in the above image processing method embodiment, and achieve the same effects and functions as the above embodiment, which will not be repeated herein.

FIG. 6 is a schematic diagram of a structure of an image processing apparatus according to another embodiment of the present disclosure. As shown in FIG. 6, the apparatus includes:
a data transmission unit 61 configured to transmit a first image sequence based on a first transmission frame rate, and transmit a second image sequence based on a second transmission frame rate, where the first image sequence includes a first image; the second image sequence includes second images; image content of each of the second images is the same as image content of a first area in the first image; and the first transmission frame rate is less than the second transmission frame rate.

Optionally, the apparatus further includes: a determination and cropping unit configured to: before the first image sequence is transmitted based on the first transmission frame rate and the second image sequence is transmitted based on the second transmission frame rate, capture the first image at a preset capture frame rate;
determine the first area in the first image; and
crop the first area in the first image, to obtain the second image.

Optionally, the determination and cropping unit is specifically configured to:
determine the first area in the first image based on a difference in image content of a plurality of first images with adjacent timestamps.

Optionally, the determination and cropping unit is specifically configured to:
rotate the first image based on the coordinates of the center point of the first area, where the coordinates of the center point of the first area in the rotated first image are located at a center of the rotated first image; and
crop the first area in the rotated first image, to obtain the second image.

Optionally, the apparatus further includes a third update unit configured to:
after the first image sequence is transmitted based on the first transmission frame rate and the second image sequence is transmitted based on the second transmission frame rate, obtain an updated coordinates of the center point of the first area; and update the first area in the first image based on the updated coordinates of the center point of the first area.

The image processing apparatus in this embodiment of the present disclosure can implement various processes in the above image processing method embodiment, and achieve the same effects and functions as the above embodiment, which will not be repeated herein.

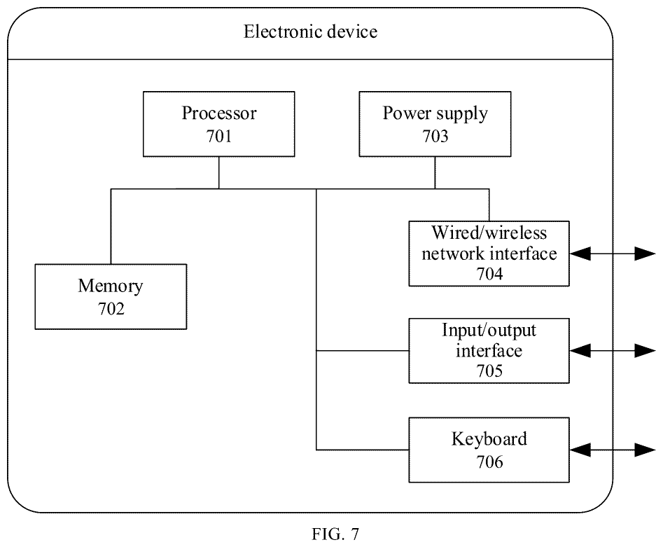

An embodiment of the present disclosure further provides an electronic device. FIG. 7 is a schematic diagram of a structure of an electronic device according to an embodiment of the present disclosure. As shown in FIG. 7, the electronic device may vary greatly depending on configurations or performance, and may include one or more processors 701 and one or more memories 702, where the memory 702 may store one or more applications or data. The memory 702 may be a temporary storage or a persistent storage. The applications stored in the memory 702 may include one or more modules (not shown in the figure), and each module may include a series of computer-executable instructions in the electronic device. Still further, the processor 701 may be configured to communicate with the memory 702 and execute a series of computer-executable instructions in the memory 702 on the electronic device. The electronic device may further include one or more power supplies 703, one or more wired or wireless network interfaces 704, one or more input or output interfaces 705, one or more keyboards 706, etc.

In a specific embodiment, the electronic device includes: a processor; and a memory configured to store computer-executable instructions that, when executed, cause the processor to implement the following process:
receiving a first image sequence transmitted based on a first transmission frame rate and a second image sequence transmitted based on a second transmission frame rate, where the first image sequence includes a first image; the second image sequence includes second images; image content of each of the second images is the same as image content of a first area in the first image; and the first transmission frame rate is less than the second transmission frame rate;
generating a third image sequence based on the first image sequence and the second image sequence, where the third image sequence includes third images; the third images are in a one-to-one correspondence with the second images; image content of the first area in each of the third images comes from the second image; and image content of areas, other than the first area, in the third image comes from the first image; and
generating a video stream based on the third image sequence and transmitting the video stream to a user.

The electronic device in this embodiment of the present disclosure can implement various processes in the above image processing method embodiment, and achieve the same effects and functions as the above embodiment, which will not be repeated herein.

In another specific embodiment, the electronic device includes: a processor; and a memory configured to store computer-executable instructions that, when executed, cause the processor to implement the following process:
transmitting a first image sequence based on a first transmission frame rate, and transmitting a second image sequence based on a second transmission frame rate, where the first image sequence includes a first image; the second image sequence includes second images; image content of each of the second images is the same as image content of a first area in the first image; and the first transmission frame rate is less than the second transmission frame rate.

The electronic device in this embodiment of the present disclosure can implement various processes in the above image processing method embodiment, and achieve the same effects and functions as the above embodiment, which will not be repeated herein.

Another embodiment of the present disclosure further provides a computer-readable storage medium for storing computer-executable instructions that, when executed by a processor, cause the following process to be implemented:
receiving a first image sequence transmitted based on a first transmission frame rate and a second image sequence transmitted based on a second transmission frame rate, where the first image sequence includes a first image; the second image sequence includes second images; image content of each of the second images is the same as image content of a first area in the first image; and the first transmission frame rate is less than the second transmission frame rate;
generating a third image sequence based on the first image sequence and the second image sequence, where the third image sequence includes third images; the third images are in a one-to-one correspondence with the second images; image content of the first area in each of the third images comes from the second image; and image content of areas, other than the first area, in the third image comes from the first image; and
generating a video stream based on the third image sequence and transmitting the video stream to a user.

The storage medium in this embodiment of the present disclosure can implement various processes in the above image processing method embodiment, and achieve the same effects and functions as the above embodiment, which will not be repeated herein.

Another embodiment of the present disclosure further provides a computer-readable storage medium for storing computer-executable instructions that, when executed by a processor, cause the following process to be implemented:
transmitting a first image sequence based on a first transmission frame rate, and transmitting a second image sequence based on a second transmission frame rate, where the first image sequence includes a first image; the second image sequence includes second images; image content of each of the second images is the same as image content of a first area in the first image; and the first transmission frame rate is less than the second transmission frame rate.

The storage medium in this embodiment of the present disclosure can implement various processes in the above image processing method embodiment, and achieve the same effects and functions as the above embodiment, which will not be repeated herein.

In various embodiments of the present disclosure, the computer-readable storage medium includes a read-only memory (ROM), a random access memory (RAM), a magnetic disk, or an optical disk, etc.

In the 1990s, improvements to a technique can be clearly distinguished between hardware improvements (e.g., improvements to a circuit structure such as a diode, a transistor, and a switch) and software improvements (improvements to a method flow). However, with the development of technology, current improvements to many method flows may be regarded as direct improvements to a hardware circuit structure. Almost all of the designers obtain a corresponding hardware circuit structure by programming an improved method flow into a hardware circuit. Therefore, it cannot be said that the improvement to a method flow cannot be implemented by a hardware entity module. For example, a programmable logic device (PLD), e.g., a field programmable gate array (FPGA) is an integrated circuit in which a logic function thereof is determined by a user by programming the device. Designers perform programming by themselves to “integrate” a digital system onto a PLD without having to ask for a chip manufacturer to design and fabricate a specialized integrated circuit chip. Moreover, nowadays, instead of manually fabricating the integrated circuit chip, this programming is mostly implemented by using “logic compiler” software, which is similar to a software compiler used for program development and writing, and the compilation of previous original code requires the original code to be written in a specific programming language, which is called hardware description language (HDL). There are a plurality of HDLs, not just one, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Currently, the most commonly used HDLs are Very-High-Speed Integrated Circuit Hardware Description Language (VHDL) and Verilog. Those skilled in the art should also understand that by simply logically programming a method flow in several hardware description languages described above and then programming same into an integrated circuit, a hardware circuit for implementing the logical method flow can be easily obtained.

The controller may be implemented in any appropriate manner. For example, the controller may take the form of, for example, a microprocessor or a processor and a computer-readable medium storing computer-readable program code (such as software or firmware) executable by the (micro) processor, a logic gate, a switch, an application specific integrated circuit (ASIC), a programmable logic controller and an embedded microcontroller. Examples of the controller include, but are not limited to, the following microcontrollers: ARC 625D, Atmel AT91SAM, Microchip PIC18F26K20 and Silicone Labs C8051F320. A memory controller may also be implemented as part of a control logic of the memory. Those skilled in the art also know that, in addition to implementing the controller solely in the form of computer-readable program code, it is absolutely possible to logically program the method steps to enable the controller to achieve the same functions in the form of a logic gate, a switch, an application specific integrated circuit, a programmable logic controller, an embedded microcontroller, etc. Therefore, such a controller can be regarded as a hardware component, and means included in the controller and used for implementing various functions can also be regarded as a structure in the hardware component. Or even, the means for implementing various functions can be regarded as both a software module for implementing the method and a structure in the hardware component.

Specifically, the systems, apparatuses, modules or units set forth in the above embodiments may be implemented by a computer chip or entity, or may be implemented by a product with a certain function. A typical implementation device is a computer. Specifically, the computer may be, for example, a personal computer, a laptop computer, a cellular phone, a camera phone, a smart phone, a personal digital assistant, a media player, a navigation device, an e-mail device, a game console, a tablet computer, a wearable device, or a combination of any of the devices.

For ease of description, when described, the above apparatus is divided into various units based on functions. Certainly, functions of the units may be implemented in one or more pieces of software and/or hardware when the embodiments of the present disclosure are implemented.

Those skilled in the art should understand that one or more embodiments of the present disclosure may be provided as a method, a system, or a computer program product. Therefore, one or more embodiment of the present disclosure may take the form of an entirely hardware embodiment, an entirely software embodiment, or an embodiment with a combination of software and hardware aspects. Furthermore, one or more embodiments of the present disclosure may take the form of a computer program product that is implemented on one or more computer-usable storage media (including, but not limited to, a disk memory, a CD-ROM, an optical memory, etc.) that include computer-usable program code.

The present disclosure is described with reference to the flowcharts and/or the block diagrams of the method, the device (system), and the computer program product according to the embodiments of the present disclosure. It should be understood that each process and/or block in the flowchart and/or block diagram, and a combination of the process and/or block in the flowchart and/or block diagram may be implemented by computer program instructions. These computer program instructions may be provided to a processor of a general-purpose computer, a special-purpose computer, an embedded processor, or another programmable data processing device to produce a machine, such that the instructions, which are executed by the processor of the computer or the other programmable data processing device, create an apparatus for implementing functions specified in one or more processes in the flowchart and/or one or more blocks in the block diagram.

These computer program instructions may also be stored in a computer-readable memory that can direct the computer or the other programmable data processing device to operate in a particular manner, such that the instructions stored in the computer-readable memory produce an article of manufacture that includes an instruction apparatus. The instruction apparatus implements the functions specified in one or more processes in the flowchart and/or one or more blocks in the block diagram.

These computer program instructions may also be loaded onto the computer or the other programmable data processing device, such that a series of operation steps are performed on the computer or the other programmable device to produce computer-implemented processing. Therefore, the instructions executed on the computer or the other programmable device provide the steps of implementing the functions specified in one or more processes in the flowchart and/or one or more blocks in the block diagram.

It should also be noted that, the terms “include” and “including”, or any other variations thereof are intended to cover a non-exclusive inclusion, so that a process, method, commodity, or device that includes a list of elements not only includes those elements, but also includes other elements that are not expressly listed, or further includes elements inherent to such process, method, commodity, or device. In the absence of more restrictions, an element defined by “including a . . . ” does not exclude another identical element in a process, method, commodity, or device that includes the element.

One or more embodiment of the present disclosure may be described in the general context of computer-executable instructions, such as a program module, executed by a computer. Generally, the program module includes a routine, a program, an object, a component, a data structure, etc., that performs a particular task or implements a particular abstract data type. One or more embodiments of the present disclosure may also be practiced in distributed computing environments where tasks are performed by remote processing devices that are connected via a communication network. In a distributed computing environment, the program module may be located in local and remote computer storage media including a storage device.

The embodiments in the present disclosure are all described in a progressive way, and mutual reference may be made to the same and similar parts of the embodiments, and each embodiment focuses on the differences from other embodiments. In particular, the system embodiment is substantially similar to the method embodiment, and is thus described in a simple manner, and for a related part, reference may be made to the part of the description of the method embodiment.

The foregoing descriptions are only embodiments of the present disclosure, and are not intended to limit the present disclosure. For those skilled in the art, various modifications and variations may be made to the present disclosure. Any modifications, equivalent substitutions, improvements, etc. made within the spirit and principle of the present disclosure shall be included within the scope of the claims of the present disclosure.

I/We claim:

1. An image processing method, comprising:
receiving a first image sequence transmitted based on a first transmission frame rate and a second image sequence transmitted based on a second transmission frame rate, wherein the first image sequence comprises a first image; the second image sequence comprises second images; image content of each of the second images is the same as image content of a first area in the first image; and the first transmission frame rate is less than the second transmission frame rate;
generating a third image sequence based on the first image sequence and the second image sequence, wherein the third image sequence comprises third images; the third images are in a one-to-one correspondence with the second images; image content of the first area in each of the third images comes from the second image; and image content of areas, other than the first area, in the third image comes from the first image; and
generating a video stream based on the third image sequence and transmitting the video stream to a user.

2. The method according to claim 1, wherein the generating a third image sequence based on the first image sequence and the second image sequence comprises:
augmenting the first image sequence based on the second transmission frame rate, wherein the first images in the augmented first image sequence are in a one-to-one correspondence with the second images;
replacing image content of the first area in the first image with the corresponding second image, wherein the first images are the third images; and
generating the third image sequence based on the third images.

3. The method according to claim 2, wherein the replacing image content of the first area in the first image with the corresponding second image comprises:
determining a coordinate correspondence between pixel points in the second image and pixel points in the first area in the first image based on a width and height of the first image, a width and height of the first area, a spherical angle range covered by the first area, and coordinates of a center point of a video picture of the user; and
replacing the pixel points in the first area in the first image with the pixel points in the corresponding second image based on the coordinate correspondence.

4. The method according to claim 1, wherein the second image sequence further comprises a fourth image; image content of the fourth image is the same as image content of a second area in the first image; and the second area is located in areas other than the first area; and the method further comprises:
determining whether to update the first image, based on a similarity between the image content of the fourth image and the image content in the second area in the first image; and
if so, updating the first image.

5. The method according to claim 1, wherein after transmitting the video stream to the user, the method further comprises:
updating coordinates of a center point of the first area in the first image based on the coordinates of the center point of the video picture of the user when watching the video stream; and
updating the first area in the first image based on the updated coordinates of the center point of the first area.

6. An image processing method, comprising:
transmitting a first image sequence based on a first transmission frame rate, and transmitting a second image sequence based on a second transmission frame rate, wherein the first image sequence comprises a first image; the second image sequence comprises second images; image content of each of the second images is the same as image content of a first area in the first image; and the first transmission frame rate is less than the second transmission frame rate.

7. The method according to claim 6, wherein before transmitting the first image sequence based on the first transmission frame rate, and transmitting the second image sequence based on the second transmission frame rate, the method further comprises:
capturing the first image according to a preset capture frame rate;
determining the first area in the first image; and
cropping the first area in the first image, to obtain the second image.

8. The method according to claim 7, wherein the determining the first area in the first image comprises:
determining the first area in the first image based on a difference in image content of a plurality of first images with adjacent timestamps.

9. The method according to claim 7, wherein the cropping the first area in the first image, to obtain the second image comprises:
rotating the first image based on the coordinates of the center point of the first area, wherein the coordinates of the center point of the first area in the rotated first image are located at a center of the rotated first image; and
cropping the first area in the rotated first image, to obtain the second image.

10. The method according to claim 6, wherein after transmitting the first image sequence based on the first transmission frame rate, and transmitting the second image sequence based on the second transmission frame rate, the method further comprises:
obtaining the updated coordinates of the center point of the first area; and
updating the first area in the first image based on the updated coordinates of the center point of the first area.

11. An electronic device, comprising:
a processor; and
a memory configured to store computer-executable instructions that, when executed, cause the processor to:
receive a first image sequence transmitted based on a first transmission frame rate and a second image sequence transmitted based on a second transmission frame rate, wherein the first image sequence comprises a first image; the second image sequence comprises second images; image content of each of the second images is the same as image content of a first area in the first image; and the first transmission frame rate is less than the second transmission frame rate;
generate a third image sequence based on the first image sequence and the second image sequence, wherein the third image sequence comprises third images; the third images are in a one-to-one correspondence with the second images; image content of the first area in each of the third images comes from the second image; and image content of areas, other than the first area, in the third image comes from the first image; and
generate a video stream based on the third image sequence and transmit the video stream to a user.

12. The electronic device according to claim 11, wherein the instructions that cause the processor to generate a third image sequence based on the first image sequence and the second image sequence further cause the processor to:
augment the first image sequence based on the second transmission frame rate, wherein the first images in the augmented first image sequence are in a one-to-one correspondence with the second images;
replace image content of the first area in the first image with the corresponding second image, wherein the first images are the third images; and
generate the third image sequence based on the third images.

13. The electronic device according to claim 12, wherein the instructions that cause the processor to replace image content of the first area in the first image with the corresponding second image further cause the processor to:
determine a coordinate correspondence between pixel points in the second image and pixel points in the first area in the first image based on a width and height of the first image, a width and height of the first area, a spherical angle range covered by the first area, and coordinates of a center point of a video picture of the user; and
replace the pixel points in the first area in the first image with the pixel points in the corresponding second image based on the coordinate correspondence.

14. The electronic device according to claim 11, wherein the second image sequence further comprises a fourth image; image content of the fourth image is the same as image content of a second area in the first image; and the second area is located in areas other than the first area; and the processor is further caused to:
determine whether to update the first image, based on a similarity between the image content of the fourth image and the image content in the second area in the first image; and
if so, update the first image.

15. The electronic device according to claim 11, wherein after the video stream is transmitted to the user, the processor is further caused to:
update coordinates of a center point of the first area in the first image based on the coordinates of the center point of the video picture of the user when watching the video stream; and
update the first area in the first image based on the updated coordinates of the center point of the first area.
